(19) United States
(12) Patent Application Publication
(10) Pub. No.: US 2005/0059746 A1
(43) Pub. Date: Mar. 17, 2005

(54) Flexible manufacture of polyethylene terephthalate ("PET")

(76) Inventors: Juan Antonio Moncada Andres, Miami, FL (US); Perry Michael Murdaugh, Lexington, SC (US); Jason Oliver Carter, Lexington, SC (US)

Correspondence Address: Dennis V. Carmen;Eastman Chemical Company, P.O. Box 511, Kingsport, TN, 37662-5075, US

(21) Appl. No.: 10/664,727

(22) Filed: Sep. 17, 2003

(51) Int. Cl. C08J 11/04; C08L 67/02

(52) U.S. Cl. 521/48; 525/437

(57) ABSTRACT

In at least one embodiment, the present invention relates to a method and system for providing blends of virgin polyethylene terephthalate (VPET) and a VPET property modifying component (PCM). In one embodiment, separate sources of solid VPET and solid PMC are provided. A conduit is provided between the sources and a bulk-container, which is suitable for delivery to an end user. VPET from the source of VPET and PMC from the PMC source are selectively dispensed into the conduit in a desired amount to form a uniform blend of materials comprising a predetermined ratio of VPET relative to PMC. The blend of materials is transported to the bulk-container for delivery to an end user.

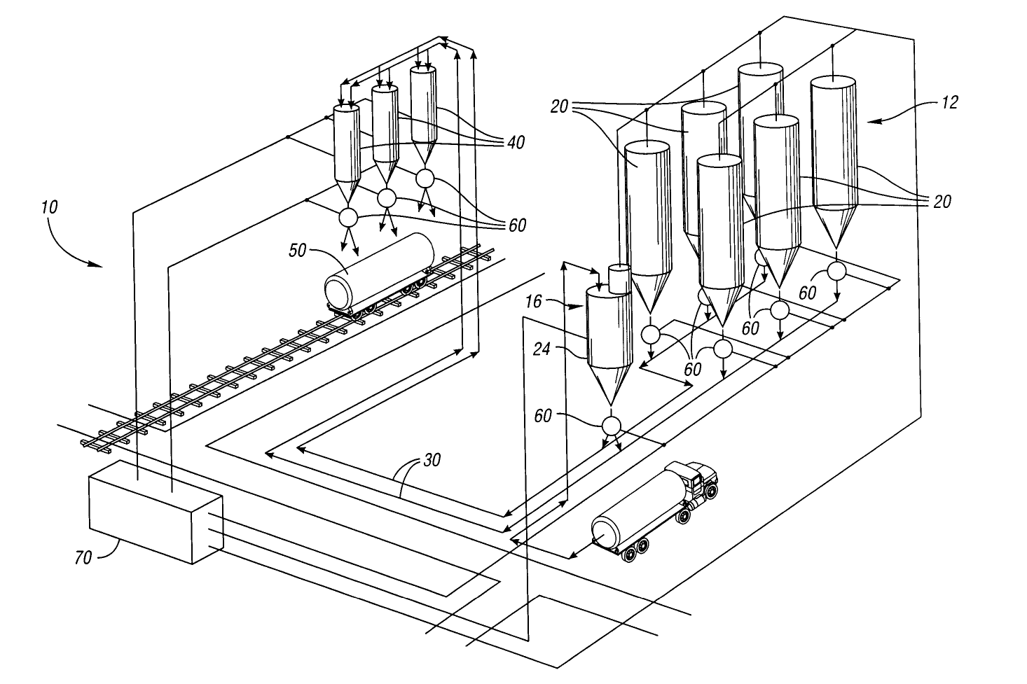

### BACKGROUND OF THE INVENTION

1. Field of the Invention

In at least one aspect, the present invention pertains to the commercial manufacture of polyethylene terephthalate (“PET”) polymers.

2. Background Art

Polyethylene terephthalate (“PET”) is an established bottle polymer that produces rigid bottles with excellent clarity and gloss. These containers are manufactured by a process that typically comprises drying the PET resin, injection molding a preform and, finally, stretch blow molding the finished bottle.

In an effort to conserve resources, blends of virgin polyethylene terephthalate (“VPET”) polymer and post-consumer recycled PET (PCR) material have been used for forming PET bottles. The blends can comprise any suitable ratio, but typically comprise between 75% to 95% VPET and 5% to 25% PCR material, on a weight basis.

The VPET and the recycled PET (PCR) are often provided to the bottle manufacturer by a PET supplier. To reduce inventory and to simplify the manufacturing process, the bottle manufacturers tend to require the blends packaged together in the same bulk-container. A variety of suitable bulk-containers have been used, such as seabulk containers, bulk trucks, railcars, gaylords and bulk bags.

A common method of providing the blends in one container has been to melt blend the VPET with the PCR material in the desired ratio and then extrude and form pellets of the blended PET material. Thus, each pellet would comprise the desired, or predetermined, ratio of VPET and PCR material. This process can obviously be time consuming and costly as it requires additional manufacturing steps, such as crystallizing and solid stating. This process could also imply a significant amount of transition material when changing from one blend to another.

However, the extrusion blending process has been typically favored relative to providing premixed containers of the VPET and the PCR material. This is because such premixed containers typically have other more problematic issues. For instance, since different ratios of VPET and PCR material are required for different applications and for different end users, it is not practical to maintain various premixed containers of VPET and PCR material. Such a practice would tend to result in an inefficient use of space, working capital and fixed capital, thus resulting in an increase in cost.

Accordingly, it would be desirable to provide a method for supplying blends of VPET and PCR material that overcome at least one of the problems in the prior art. Furthermore, it is also desirable to provide blends of VPET with materials other than PCR material. As such, it is also desired to supply these types of blends without one or more of the prior art problem.

### SUMMARY OF THE INVENTION

In at least one embodiment, the present invention relates to a method of supplying a blend of VPET and a VPET property modifying component (PMC). The method comprises providing a source of VPET and a source of PMC, separate from the source of VPET. The method further comprises providing a bulk-container for delivery of the blend to an end user. The method further comprises providing a conduit that extends between the sources and the bulk-container. The method further comprises selectively dispensing VPET and PMC from their respective sources into the conduit in a desired amount to form a blend of VPET and PMC comprising a predetermined ratio of VPET and PMC. The method further comprises transporting at least a portion of the blend from the housing to the bulk-container for delivery to the end user.

In at least one embodiment, the source of VPET preferably comprises a storage bin, such as one or more silos, containing solid VPET. In at least one embodiment, the source of PMC also preferably comprises a storage bin, such as one or more silos, containing solid PMC. Typically, because of the ratio of VPET to PMC, the source of VPET usually comprises a plurality of silos while the source of PMC usually comprises only one silo.

In at least one embodiment, the PMC is post-consumer recycled PET (PCR). In some embodiments, the blend of material comprises between 75% and 95% VPET and 5% to 25% PCR (weight or volume percent), but can range from 5% to 95% VPET and 95% to 5% PCR.

In at least one embodiment, each of the sources of material (VPET and PMC) is in fluid communication with a loading bin to allow delivery of the dry solid materials to the loading bin, prior to being transported to the bulk-container. In at least one embodiment, the fluid communication is preferably provided by pneumatic dense or diluted phase conveying conduits or transfer lines. In at least one embodiment, a CPU containing a blending program is provided to aid the blending process, hence reducing the possibility of human error or missed operation.

The above features, and other features and advantages of the present invention are readily apparent from the following detailed description thereof when taken in connection with the accompanying drawing.

### BRIEF DESCRIPTION OF THE DRAWINGS

The invention will now be described in greater detail in the following way of example only and with reference to the attached drawing, in which:

The FIGURE schematically illustrates a blending system in accordance with the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. The FIGURE is not necessarily to scale, some features may be exaggerated or minimized to show details of particular components. Therefore, specific structural and functional details disclosed herein are not to be interpreted as limiting, but merely as a representative bases for the claims and/or as a representative basis for teaching one skilled in the art to variously employ the present invention.

Except where otherwise expressly indicated, all numerical quantities herein indicating amounts of material are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; and the first definition of an acronym or other abbreviation applies to all subsequent uses herein of the same abbreviation and applies mutatis mutandis to normal grammatical variations of the initially defined abbreviation.

With reference to the FIGURE, the present invention will now be described in greater detail. As shown schematically in the FIGURE, the present invention relates to a method and a system for providing blends of VPET and VPET property modifying component (PMC). The system comprises a source 12 of VPET (virgin polyethylene terephthalate) and a source 16 of PMC. In at least one embodiment, the VPET is provided in solid form, and is more preferably provided as solid pellets. However, it should be understood that the VPET could be provided in other solid form, such as flakes and strands. The VPET can be made by any suitable process.

In at least one embodiment, as shown in the FIGURE, the source of VPET 12 comprises a plurality of storage containers 20 containing the VPET. The storage containers 20 can be any suitable shape size and design, and in at least one embodiment, comprise a plurality of silos. A silo can typically contain 50-700 metric tons (mt) of VPET. While the source of VPET can comprise any suitable volume, since the present invention more preferably lends itself to large scale operations, the source of VPET, in at least one embodiment, comprises 100-10,000 metric tons (mt), and more preferably 500-2,000 mt.

The source of PMC 16 is preferably any suitable storage container and, as is shown in one embodiment in the FIGURE, is preferably a silo 24. In at least one embodiment, the PMC is provided in solid form, and is more preferably provided as solid pellets. However, it should be understood that the PMC can also be in the form of short strands, flakes, microspheres, powder, or coating on a carrier, such as solid VPET. While the source of PMC can comprise any suitable volume, since the present invention more preferably lends itself to large scale operations, the source of PMC, in at least one embodiment, comprises 1-3,000 metric tons (mt) and more preferably 20-300 metric tons.

The PMC is any suitable material that when blended with VPET forms a blend that when molded has a different property or characteristic than similarly molded unmodified VPET. Suitable examples of PMC include, but are not limited to, PCR materials such as post consumer recycled PET (PCR), VPET reheat characteristic modifying agents, VPET crystallization rate modifying agents, VPET UV (ultraviolet light) cutoff wavelength modifying agents, VPET acetaldehyde (AA) reducing and/or scavenging agents, VPET oxygen barrier and/or scavenging agents, VPET gas barrier property modifying agents, VPET natural stretch ratio modifying agents, VPET coefficient of friction modifying agents, and VPET processing agents.

For the VPET reheat characteristic modifying agents, any suitable component that modifies the reheat characteristics of the VPET can be used. Suitable examples of such components include, but are not necessarily limited to, a reactor made concentrate or a dispersion in a polyethylene terephthalate matrix of a black body, element or compound, able to absorb light in the near infrared range of the visible light spectra.

For the VPET crystallization rate modification agents, any suitable material that modifies the crystallization rate of the VPET can be used. Suitable examples include copolyesters of cyclohexanedimethanol, naphthalene, isophthalic acid, ethylene glycol or any other co-monomer suitable for polyester condensation, with modification greater than 10% by weight.

For the VPET UV cutoff wavelength modifying agents, any suitable material that modifies the VPET UV cutoff wavelength can be used. Suitable examples include, but are not necessarily limited to, a reactor made concentrate or a dispersion in a polyethylene terephthalate matrix of an element or compound with strong absorbance in the ultraviolet range of the visible light spectra, or element or compound able to scatter or refract said light as well.

For the VPET AA reducing and/or scavenging agents, any suitable material that modifies the VPET's characteristic relevant to acetaldehyde (AA) generation and/or scavenging of AA can be used. Suitable examples include, but are not necessarily limited to, a reactor made concentrate or dispersion in a polyethylene terephthalate matrix of an element or compound with the ability to deter the formation of acetaldehyde gasses during processing of VPET and/or to scavenge acetaldehyde gasses upon formation during processing of VPET.

For the VPET oxygen barrier and/or scavenging agents, any suitable material that modifies the VPET's characteristic relative to oxygen barrier and/or scavenging of oxygen can be used. Suitable examples include, but are not necessarily limited to, a reactor made concentrate or dispersion in a polyethylene terephthalate matrix of an element or compound that scavenges or absorbs oxygen as it attempts to pass through the formed article walls, thus slowing exposure of contained product in the formed article and extending product shelf life.

For the VPET gas barrier modifying agents, any suitable material that modifies the PET's gas barrier property can be used. Suitable examples include, but are not necessarily limited to, polyethylene naphthalate homopolymer or copolymer or a reactor made concentrate or a dispersion in a polyethylene terephthalate matrix of an element or compound that increase the tortuous path for the gas molecules to diffuse through the molded article.

For the VPET natural stretch modifying agents, any suitable material that modifies the natural stretch ratio characteristics of the VPET can be used. Suitable examples of such material include, but are not necessarily limited to, di-ethylene glycol (DEG), tri-ethylene glycol (TEG), cyclohexane di-methanol (CHDM), neopenthyl glycol (NPG), EX20, Irganox 626 or other suitable co-monomers for the production of polyesters.

For the VPET coefficient of friction modifying agents, any suitable material that modifies the VPET's coefficient of friction can be used. Suitable examples of such materials include, but are not necessarily limited to, a reactor made concentrate or dispersion in a polyethylene terephthalate matrix of an element or compound that on a microscopic level increases the roughness of the molded article surface or provides lubrication of the molded article surfaces to reduce the friction or the tendency of the molded article to stick to or attach to a similar article.

For the VPET processing agents, any material that improves the processability of VPET may be used. Suitable examples of such materials include, but are not necessarily limited to, a copolyester of cyclohexanedimethanol, naphthalene, isophthalic acid, ethylene glycol or any other co-monomer suitable for polyester condensation, with modification greater than 10% by weight.

The amount of the VPET relative to the PMC can vary depending upon the desired end use and the desired end user. The amount is typically between 0.01%-40% by weight, but can vary as needed. However, in certain embodiments, the amount of property modifying component in a resulting blend of PMC (property modifying component) and VPET may be, on a weight basis, as follows:
5%-30%, and more preferably 10%, of PCR, such as post consumer recycled PET;
5%-30%, and more preferably 10%, of VPET reheat characteristics modifying agents;
5%- 40%, and more preferably 10%, of VPET crystallization modifying agents;
0.1%-15%, and more preferably 2%, of VPET UV (ultraviolet light) cutoff wavelength agents;
0.1%-10%, and more preferably 0.3%, of VPET acetaldehyde (AA) reducing and/or scavenging modifying agents;
0.5%-15%, and more preferably 15%, of VPET oxygen barrier and/or scavenging agents;
5%-40%, and more preferably 15%, of VPET gas barrier property modifying agents;
5%-40%, and more preferably 15%, of VPET natural stretch ratio modifying agents;
0.5%-15%, and more preferably 2%, of VPET coefficient of friction modifying agents; and
2% -30%, and more preferably 5%, of VPET processing agents.

In at least one preferred embodiment, the PMC comprises post-consumer recycle PET (PCR). In this embodiment, the PCR is a solid provided in pellet form. The size of the pellet of the PCR is typically between 1 and 6 millimeters with cubic, cylindrical, spherical or round shape. The PCR could also be flake form with a typical size of 1 square centimeter. The PCR can be manufactured in accordance with any suitable technique. Since the PCR is the preferred PCM, the remainder of this application will be described with respect to PCR, however, it should be understood that other non-PCR PMCs could alternatively be used and that the following description does not limit the invention to use of PCR only.

The PCR is contained in silo 24. Silos 20 and 24 are connected via conduits 30 to one or more loading bins 40. While the loading bins 40 can be any suitable size, since the present invention more preferably lends itself to large scale operations, the loading bin 40, in at least one embodiment, can hold a volume of 100-700 mt of material. Conduits 30 deliver PCR from silo 24 and VPET from one or more of silos 20 to one or more of the loading bins 40. In one embodiment, as shown in the FIGURE, silo 24 is downstream of silos 20 and upstream of loading bins 40. In the FIGURE, two separate conduits 30 are shown to extend between silo 20 and loading bins 40. It should be understood that this is merely representative such that more, such as eight (one for each silo), or less could be employed.

Conduits 30 are preferably pneumatic conveying lines suitable for transferring solid material. However, it should be understood that other devices or equipment that are suitable for delivering solid material can be used in addition to or in place of the pneumatic conveying lines as schematically represented in the FIGURE. Examples of suitable devices include, but are not limited to pneumatic dilute phase transfer systems, pneumatic dense phase transfer systems, augers, conveyer belts, vibrator conveyors, etc. Other components that may be in transfer lines include, but are not necessarily limited to, gravity feed lines, vacuum pumps, positive displacement pumps, mesh or solid convey tubing, grooved convey tubing, vents, flow and directional valves, compressor, etc.

The silos 20 and 24 can communicate with CPU 70 containing program blending to facilitate the dispensing of materials through valves 60 into the conduits 30. The valves 60 can be any suitable valves, such as on/off valves, metering valves, and/or rotary air lock valves, positioned between each silo 20, 24 and 40 and a conduit 30 or 50 container to control the flow of material into the conduits 30 or container 50. With respect to the silos 20 and 24, the valves 60 provide isolation between the silos 20 and 24 and their respective conduits 30. These valves 60 allow the discharge of VPET and PCR into the conduits 30 that convey the materials to the loading bins 40.

In one embodiment, the silos 20 and 24 are preferably on conventional load cells and have conventional laser level measurement system to monitor and help control the amounts (levels) and dispensing of the materials in the silos. The CPU 70 is connected with the silos 20 and 24 and the loading bins 40 to control the feed rate of the VPET and the PCR to obtain and maintain the desired VPET/PCR ratio. In one embodiment, the CPU 70 contains a blending program that operates to control the opening and closing of the valves 60 that are at the bottom of the silos 20 and 24. It should be noted that the CPU could employ several different methods, separate or in any combination, to achieve the target mixing of PCR (PMC) and VPET. Examples of the methods include, but are not limited to, change in silo weights, change in silo levels, and speed of the rotary lock valves among others.

The PCR and the VPET are uniformly mixed and conveyed to the loading bin 40 in the desired predetermined ratio that is to be disseminated in the bulk-container 50. In one embodiment, the valve 60 between silo 24 and conduits 30 controls the amount of PCR mixed with the VPET. In addition to the valve 60, any suitable mixing device that uniformly mixes the VPET and PCR can be used. In certain embodiments, preferably a rotary air lock valve or a dry solids mixing screw is employed. In some embodiments, the conduits 30 could aid in the mixing by using specially configured and/or treated transfer lines or internal blend tubes (either side or bottom mounted). Furthermore, loading bin could also contain an additional mixer, as is conventional in certain silos and containers.

As shown schematically in the FIGURE, a bulk-container 50 is provided underneath one of the loading bins 40. Container 50 is any suitable container for transporting bulk amounts of the blend of material and as is shown in the FIGURE is preferably seabulk containers, bulk trucks, railcars, gaylords or bulk bags. While the bulk-container can be any suitable size, since the present invention more preferably lends itself to large scale operations, the bulk-container 40, in at least one embodiment, can hold a volume of 100-700 mt of material.

The loading bin 40 has a receiving opening 54 and a dispensing opening 56. Receiving opening 54 is disposed axially above dispensing opening 56. The uniformly mixed blend of the PCR and the VPET are deposited into loading bin 40 through opening from conduits 30. Inside the bins 40, the blend of the PCR and VPET can continue to be mixed to maintain, or even further attain, a uniform mix of the blend 62 of solid material, employing conventional equipment.

Blend 62 comprises the VPET and the PCM in the desired ratio. In certain embodiments the predetermined/desired ratio comprises 75% to 95% VPET and 5% to 25% PCM, on a weight basis, however, this could also be on a volume basis. The blend of material 62, or at least a portion of the blend 62, can be delivered through opening 56 into bulk-container 50 where it is then transported to the end user for use in the end user manufacturing plants.

While embodiments of the invention have been illustrated and described, it is not intended that these embodiments illustrate and describe all possible forms of the invention. For instance, this invention is applicable to materials that are similar to VPET, such as low, high, linear or medium density polyethylene, polypropylene, polycarbonate, and any other polymeric material in pellet form that are similar to VPET. Rather, the words used in the specification are words of description rather than limitation, and it is understood that various changes may be made without departing from the spirit and scope of the invention.

1. A method for providing a homogenized blend of VPET and a PCM, said method comprising:
providing a source of solid VPET;
providing a source of solid PMC, separate from the source of VPET;
providing a bulk-container for delivery of the blend to an end user;
providing a conduit between the sources and the bulk-container;
selectively dispensing VPET from the source of VPET and PMC from the source of PMC into the conduit in a desired amount to form a uniform blend of materials comprising a predetermined ratio of VPET relative to PMC in the conduit; and
transporting at least a portion of the blend in the conduit to the bulk-container for delivery to an end user.

2. The method of claim 1 wherein the PMC comprises PCR (post-consumer recycled PET).

3. The method of claim 1 wherein the PMC comprises a non-recycled PET material.

4. The method of claim 3 wherein the PMC comprises a material that, when blended with VPET, forms a blend that when molded has a substantial different characteristic than molded unmodified VPET.

5. The method of claim 3 wherein the PMC is a material selected from the group consisting of VPET reheat characteristic modifying agents, VPET crystallization rate modifying agents, VPET UV (ultraviolet light) cutoff wavelength modifying agents, VPET acetaldehyde (AA) reducing and/or scavenging agents, VPET oxygen barrier and/or scavenging agents, VPET gas barrier property modifying agents, VPET natural stretch ratio modifying agents, VPET coefficient of friction modifying agents, and VPET processing agents.

6. The method of claim 2 wherein the blend of materials comprises 5% to 25% PCR and 75% to 95% VPET.

7. The method of claim 1 wherein a loading bin is disposed between the conduit and the bulk-container, the loading bin being suitable for storing large quantities of the blend.

8. The method of claim 1 wherein the step of dispensing material from the sources of VPET and PMC comprise dispensing one of the materials into the conduit at a first location and dispensing the other of the materials into the conduit at a second location between the first location and the bulk-container.

9. The method of claim 1 further comprising a CPU for controlling the dispensing of materials from the sources and the mixing of the blends.

10. A system for providing a blend of VPET and a PCM, the system comprising:
a source of solid VPET;
a source of solid PMC, separate from the source of VPET;
a conduit in fluid communication with the sources of material, the conduit and the sources being configured to provide a uniform blend of materials comprising the VPET and the PMC in the conduit; and
a bulk-container capable of receiving the blend of materials.

11. The system of claim 10 wherein the PMC comprises PCR (post-consumer recycled PET).

12. The system of claim 10 wherein the PMC comprises a non-recycled PET material.

13. The system of claim 12 wherein the PMC comprises a material that, when blended with VPET, forms a blend that when molded has a substantial different characteristic than molded unmodified VPET.

14. The system of claim 12 wherein the PMC is a material selected from the group consisting of VPET reheat characteristic modifying agents, VPET crystallization rate modifying agents, VPET UV (ultraviolet light) cutoff wavelength modifying agents, VPET acetaldehyde (AA) reducing and/or scavenging agents, VPET oxygen barrier and/or scavenging agents, VPET gas barrier property modifying agents, VPET natural stretch ratio modifying agents, VPET coefficient of friction modifying agents, and VPET processing agents.

15. The system of claim 11 wherein the blended materials comprises 5% to 25% PCR and 75% to 95% VPET.

16. The system of claim 10 wherein a loading bin is disposed between the conduit and the bulk-container, the loading bin being suitable for storing large quantities of the blend.

17. The system of claim 10 wherein the sources each have a valve between each source and the conduit.

18. The system of claim 17 wherein the valve comprises a rotary air lock valve.

19. The system of claim 10 further comprising a CPU for controlling the dispensing of materials from the sources.

20. A method for providing a homogenized blend of VPET and a PCM, said method comprising:
providing a source of solid VPET;
providing a source of solid PMC, separate from the source of VPET;
providing a load in bin;
providing a conduit that extends between the sources and the loading bin;
selectively dispensing VPET from the source of VPET and PMC from the source of PMC into the conduit in a desired amount to form a uniform blend of materials comprising a predetermined ratio of VPET relative to PMC in the conduit; and
transporting at least a portion of the blend in the conduit to the loading bin into a bulk-container for delivery to an end user.
